(19) United States
(12) Patent Application Publication
(10) Pub. No.: US 2024/0196982 A1
(43) Pub. Date: Jun. 20, 2024

(54) AEROSOL GENERATING DEVICE INCLUDING MAGNETIC SENSOR

(71) Applicant: KT&G CORPORATION, Daejeon (KR)

(72) Inventors: Dong Sung KIM, Seoul (KR); Youngbum KWON, Yongin-si (KR); Yong Hwan KIM, Anyang-si (KR); Hunil LIM, Seoul (KR); Seok Su JANG, Daejeon (KR)

(73) Assignee: KT&G CORPORATION, Daejeon (KR)

(21) Appl. No.: 18/285,979

(22) PCT Filed: Feb. 7, 2023
(86) PCT No.: PCT/KR2023/001681

§ 371 Date: Oct. 6, 2023

(30) Foreign Application Priority Data
Feb. 8, 2022 (KR) 10-2022-0016124
Jun. 17, 2022 (KR) 10-2022-0074092

(51) Int. Cl. A24F 40/51; A24F 40/20; A24F 40/465; H05B 6/10; H05B 6/36

(52) U.S. Cl. CPC A24F 40/51; A24F 40/20; A24F 40/465; H05B 6/10; H05B 6/36

(57) ABSTRACT

An aerosol generating device includes a heating housing configured to receive an aerosol generating article, a first coil disposed in the heating housing and configured to generate a magnetic field, and a first magnetic sensor configured to detect a change in the magnetic field generated by the first coil.

### TECHNICAL FIELD

The disclosure relates to an aerosol generating device, for example, to an aerosol generating device including a magnetic sensor.

### BACKGROUND ART

Techniques for introducing airflow into an aerosol generating article have been developed to improve atomization performance. For example, aerosol generating devices that generate an aerosol from an aerosol generating article in a non-burning manner are being developed.

### DISCLOSURE OF INVENTION

### Technical Problem

One aspect of the disclosure may provide an aerosol generating device including a magnetic sensor configured to detect magnetic field characteristics.

### Solution to Problem

According to an embodiment, an aerosol generating device includes a heating housing configured to receive an aerosol generating article, a first coil disposed on the heating housing and configured to generate a magnetic field, and a first magnetic sensor configured to detect a change in the magnetic field generated by the first coil.

In an embodiment, the first magnetic sensor may be disposed adjacent to the first coil.

In an embodiment, the first coil and the first magnetic sensor may be arranged to at least partially overlap in one radial direction of the heating housing.

In an embodiment, the first coil may have an axis in a longitudinal direction of the heating housing.

In an embodiment, the aerosol generating device may further include a shielding portion configured to block electromagnetic waves and arranged to at least partially surround the first magnetic sensor.

In an embodiment, the aerosol generating device may further include a second coil disposed in a region of the heating housing which is different from a region in which the first coil is disposed, and configured to generate a magnetic field, and a second magnetic sensor configured to detect a change in the magnetic field generated by the second coil.

In an embodiment, the second magnetic sensor may be disposed opposite to the second coil on the heating housing.

In an embodiment, the second coil and the second magnetic sensor may be arranged to at least partially overlap in one axis direction of the heating housing.

In an embodiment, the second coil may have an axis in a normal direction of a side surface of the heating housing.

In an embodiment, the aerosol generating device may further include a shielding portion configured to block electromagnetic waves and arranged to at least partially surround the second magnetic sensor.

According to an embodiment, an aerosol generating system includes an aerosol generating article including a susceptor, and an aerosol generating device including a heating housing configured to receive the aerosol generating article, a first coil disposed on the heating housing, positioned to be electromagnetically coupled to the susceptor when the aerosol generating article is loaded in the aerosol generating device, and configured to generate a magnetic field, and a first magnetic sensor configured to detect a change in the magnetic field generated by the first coil.

In an embodiment, the first magnetic sensor may be disposed adjacent to the first coil.

In an embodiment, the aerosol generating device may further include a second coil disposed in a region of the heating housing which is different from a region in which the first coil is disposed, positioned to be electromagnetically coupled to the susceptor when the aerosol generating article is loaded in the aerosol generating device, and configured to generate a magnetic field, and a second magnetic sensor configured to detect a change in the magnetic field generated by the second coil.

In an embodiment, the second magnetic sensor may be disposed opposite to the second coil on the heating housing.

In an embodiment, the first coil and the first magnetic sensor may be arranged to at least partially overlap in one radial direction of the heating housing, and the second coil and the second magnetic sensor may be arranged to at least partially overlap in the axis direction of the heating housing.

### Advantageous Effects of Invention

According to an embodiment, a profile for changing a current and/or a voltage by detecting a magnetic field may be set. According to an embodiment, a puff may be detected and puff detection may be displayed according to a change in a magnetic field. The effects of the aerosol generating device according to one embodiment are not limited to the above-mentioned effects, and other unmentioned effects can be clearly understood from the following description by one of ordinary skill in the art.

### BRIEF DESCRIPTION OF DRAWINGS

FIGS. 1 to 3 are diagrams illustrating examples of an aerosol generating article (e.g., a cigarette) inserted into an aerosol generating device according to an embodiment.

FIGS. 4 and 5 are diagrams illustrating examples of an aerosol generating article (e.g., a cigarette) according to an embodiment.

FIG. 6 is a block diagram of an aerosol generating device according to an embodiment.

FIG. 7 is a perspective view of a portion of an aerosol generating device according to an embodiment.

FIG. 8 is a side view of a portion of an aerosol generating device according to an embodiment.

FIG. 9 is a cross-sectional view of a portion of an aerosol generating device according to an embodiment.

FIG. 10 is a cross-sectional view of a portion of an aerosol generating system according to an embodiment.

### MODE FOR THE INVENTION

The terms used in the embodiments are selected from among common terms that are currently widely used, in consideration of their function in the disclosure. However, the terms may become different according to an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and may be implemented as hardware, software, or a combination of hardware and software.

Hereinbelow, embodiments of the disclosure will be described in detail with reference to the accompanying drawings so that the embodiments may be readily implemented by one of ordinary skill in the technical field to which the disclosure pertains. However, the present invention may be implemented in many different forms and is not limited to the embodiments described herein.

Hereinafter, embodiments of the disclosure will be described in detail with reference to the drawings.

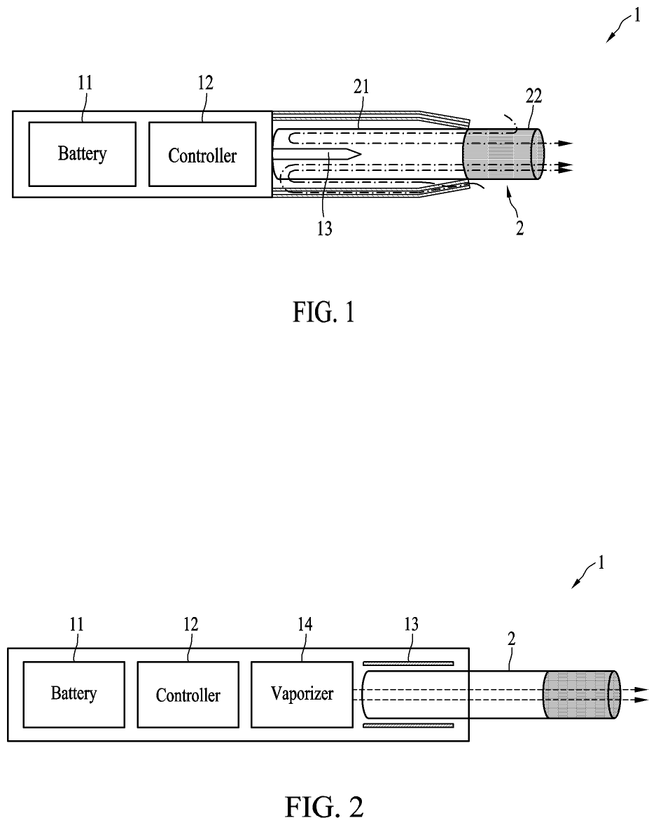

FIGS. 1 to 3 are diagrams illustrating examples of an aerosol generating article inserted into an aerosol generating device according to an embodiment.

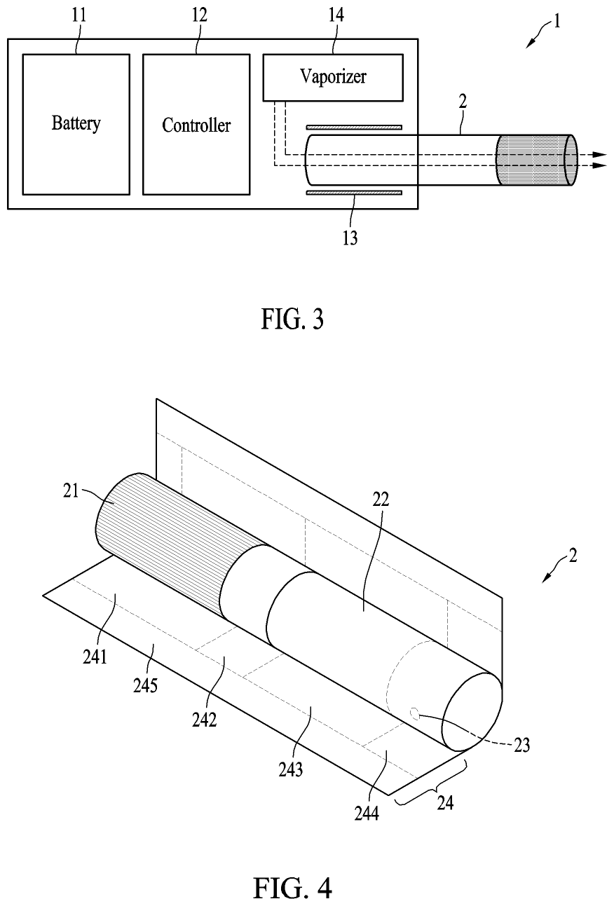

Referring to FIG. 1, an aerosol generating device 1 may include a battery 11, a controller 12, and a heater 13. Referring to FIGS. 2 and 3, the aerosol generating device 1 may further include a vaporizer 14. A cigarette 2 may be inserted into an inner space of the aerosol generating device 1.

The aerosol generating device 1 shown in FIGS. 1 to 3 may include components related to an embodiment described herein. Therefore, it is to be understood by one of ordinary skill in the art to which the disclosure pertains that the aerosol generating device 1 may further include other general-purpose components in addition to the ones shown in FIGS. 1 to 3.

In addition, although it is shown that the heater 13 is included in the aerosol generating device 1 in FIGS. 2 and 3, the heater 13 may be omitted as needed.

FIG. 1 illustrates a linear arrangement of the battery 11, the controller 12, and the heater 13. FIG. 2 illustrates a linear arrangement of the battery 11, the controller 12, the vaporizer 14, and the heater 13. FIG. 3 illustrates a parallel arrangement of the vaporizer 14 and the heater 13. However, the internal structure of the aerosol generating device 1 is not limited to what is shown in FIGS. 1 to 3. That is, the arrangements of the battery 11, the controller 12, the heater 13, and the vaporizer 14 may be changed depending on the design of the aerosol generating device 1.

When the cigarette 2 is inserted into the aerosol generating device 1, the aerosol generating device 1 may operate the heater 13 and/or the vaporizer 14 to generate an aerosol. The aerosol generated by the heater 13 and/or the vaporizer 14 may pass through the cigarette 2 into the user.

Even when the cigarette 2 is not inserted in the aerosol generating device 1, the aerosol generating device 1 may heat the heater 13, as needed.

The battery 11 may supply power to be used to operate the aerosol generating device 1. For example, the battery 11 may supply power to heat the heater 13 or the vaporizer 14, and may supply power required for the controller 12 to operate. In addition, the battery 11 may supply power required to operate a display, a sensor, a motor, or the like installed in the aerosol generating device 1.

The controller 12 may control the overall operation of the aerosol generating device 1. Specifically, the controller 12 may control respective operations of other components included in the aerosol generating device 1, in addition to the battery 11, the heater 13, and the vaporizer 14. In addition, the controller 12 may verify a state of each of the components of the aerosol generating device 1 to determine whether the aerosol generating device 1 is in an operable state.

The controller 12 may include at least one processor. The at least one processor may be implemented as an array of a plurality of logic gates, or may be implemented as a combination of a general-purpose microprocessor and a memory in which a program executable by the microprocessor is stored. In addition, it is to be understood by one of ordinary skill in the art to which the disclosure pertains that the at least one processor may be implemented in other types of hardware.

The heater 13 may be heated by power supplied by the battery 11. For example, when a cigarette is inserted in the aerosol generating device 1, the heater 13 may be disposed outside the cigarette. The heated heater 13 may thus raise the temperature of an aerosol generating material in the cigarette.

The heater 13 may be an electrically resistive heater. For example, the heater 13 may include an electrically conductive track, and the heater 13 may be heated as a current flows through the electrically conductive track. However, the heater 13 is not limited to the foregoing example, and any example of heating the heater 13 up to a desired temperature may be applicable without limitation. Here, the desired temperature may be preset in the aerosol generating device 1 or may be set by the user.

As another example, the heater 13 may be an induction heater. Specifically, the heater 13 may include an electrically conductive coil for heating the cigarette in an induction heating manner, and the cigarette may include a susceptor to be heated by the induction heater.

The heater 13 may include a heating element, which may have various shapes. For example, the heating element may include a tubular heating element, a plate-shaped heating element, a needle-shaped heating element, or a rod-shaped heating element, and may heat the inside or outside of the cigarette 2 according to the shape of a heating element.

In addition, the heater 13 may be provided as a plurality of heaters in the aerosol generating device 1. In this case, the plurality of heaters 13 may be disposed to be inserted into the cigarette 2, or may be disposed outside the cigarette 2. In addition, some of the heaters 13 may be disposed to be inserted into the cigarette 2, and the rest may be disposed outside the cigarette 2. However, the shape of the heater 13 is not limited to what is shown in FIGS. 1 through 3 but may be provided in various shapes.

The vaporizer 14 may heat a liquid composition to generate an aerosol, and the generated aerosol may pass through the cigarette 2 into the user. That is, the aerosol generated by the vaporizer 14 may travel along an airflow path of the aerosol generating device 1, and the airflow path may be configured such that the aerosol generated by the vaporizer 14 may pass through the cigarette into the user.

For example, the vaporizer 14 may include a liquid storage, a liquid transfer means, and a heating element. However, embodiments are not limited thereto. For example, the liquid storage, the liquid transfer means, and the heating element may be included as independent modules in the aerosol generating device 1.

The liquid storage may store the liquid composition. For example, the liquid composition may be a liquid including a tobacco-containing material having a volatile tobacco flavor ingredient, or a liquid including a non-tobacco material. The liquid storage may be manufactured to be detachable and attachable from and to the vaporizer 14, or may be manufactured in an integral form with the vaporizer 14.

The liquid composition may include, for example, water, a solvent, ethanol, a plant extract, a fragrance, a flavoring agent, or a vitamin mixture. The fragrance may include, for example, menthol, peppermint, spearmint oil, various fruit flavor ingredients, and the like. However, embodiments are not limited thereto. The flavoring agent may include ingredients that provide the user with a variety of flavors or scents. The vitamin mixture may be a mixture of at least one of vitamin A, vitamin B, vitamin C, or vitamin E. However, embodiments are not limited thereto. The liquid composition may also include an aerosol former such as glycerin and propylene glycol.

The liquid transfer means may transfer the liquid composition in the liquid storage to the heating element. The liquid transfer means may be, for example, a wick such as cotton fiber, ceramic fiber, glass fiber, or porous ceramic. However, embodiments are not limited thereto.

The heating element may be an element configured to heat the liquid composition transferred by the liquid transfer means. The heating element may be, for example, a metal heating wire, a metal heating plate, a ceramic heater, or the like. However, embodiments are not limited thereto. In addition, the heating element may include a conductive filament such as a nichrome wire, and may be arranged in a structure wound around the liquid transfer means. The heating element may be heated as a current is supplied and may transfer heat to the liquid composition in contact with the heating element, and may thereby heat the liquid composition. As a result, an aerosol may be generated.

For example, the vaporizer 14 may also be referred to as a cartomizer or an atomizer. However, embodiments are not limited thereto.

Meanwhile, the aerosol generating device 1 may further include general-purpose components in addition to the battery 11, the controller 12, the heater 13, and the vaporizer 14. For example, the aerosol generating device 1 may include a display that outputs visual information and/or a motor that outputs tactile information. In addition, the aerosol generating device 1 may include at least one sensor (e.g., a puff sensor, a temperature sensor, a cigarette insertion detection sensor, etc.). In addition, the aerosol generating device 1 may be manufactured to have a structure in which external air may be introduced or internal gas may flow out even with the cigarette 2 being inserted.

Although not shown in FIGS. 1 to 3, the aerosol generating device 1 may constitute a system along with a separate cradle. For example, the cradle may be used to charge the battery 11 of the aerosol generating device 1. Alternatively, the cradle may be used to heat the heater 13, with the cradle and the aerosol generating device 1 coupled.

The cigarette 2 may be of a similar type to a general burning type. For example, the cigarette 2 may be divided into a first portion including an aerosol generating material and a second portion including a filter or the like. Alternatively, the second portion of the cigarette 2 may also include the aerosol generating material. For example, the aerosol generating material provided in the form of granules or capsules may be inserted into the second portion.

The first portion may be entirely inserted into the aerosol generating device 1, and the second portion may be exposed outside. Alternatively, only the first portion may be partially inserted into the aerosol generating device 1, or the first portion may be entirely into the aerosol generating device 1 and the second portion may be partially inserted into the aerosol generating device 1. The user may inhale the aerosol with the second portion in their mouth. In this case, the aerosol may be generated as external air passes through the first portion, and the generated aerosol may pass through the second portion into the mouth of the user.

For example, the external air may be introduced through at least one air path formed in the aerosol generating device 1. In this example, the opening or closing and/or the size of the air path formed in the aerosol generating device 1 may be adjusted by the user. Accordingly, an amount of atomization, a sense of smoking, or the like may be adjusted by the user. For another example, the external air may be introduced into the inside of the cigarette 2 through at least one hole formed on a surface of the cigarette 2.

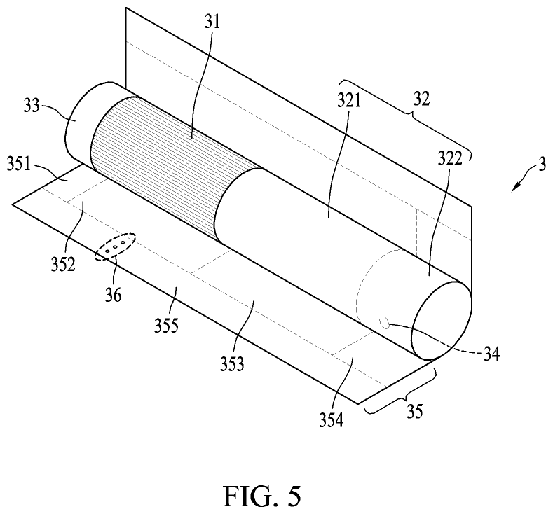

Hereinafter, examples of the cigarette 2 will be described with reference to FIGS. 4 and 5.

FIGS. 4 and 5 are perspective views of examples of a cigarette according to an embodiment.

Referring to FIG. 4, the cigarette 2 may include a tobacco rod 21 and a filter rod 22. The first portion and the second portion described above with reference to FIGS. 1 to 3 may include the tobacco rod 21 and the filter rod 22, respectively.

Although the filter rod 22 is illustrated as having a single segment in FIG. 4, examples of which are not limited thereto. That is, alternatively, the filter rod 22 may include a plurality of segments. For example, the filter rod 22 may include a segment that cools an aerosol and a segment that filters a predetermined ingredient contained in an aerosol. In addition, the filter rod 22 may further include at least one segment that performs another function, as needed.

The diameter of the cigarette 2 may be in a range of about 5 millimeters (mm) to about 9 mm, and the length thereof may be about 48 mm. However, embodiments are not limited thereto. For example, the length of the tobacco rod 21 may be about 12 mm, the length of a first segment of the filter rod 22 may be about 10 mm, the length of a second segment of the filter rod 22 may be about 14 mm, and the length of a third segment of the filter rod 22 may be about 12 mm. However, embodiments are not limited thereto.

The cigarette 2 may be wrapped with at least one wrapper 24. The wrapper 24 may have at least one hole through which external air is introduced or internal gas is discharged outside. For example, the cigarette 2 may be wrapped with one wrapper 24. For another example, the cigarette 2 may be wrapped with two or more wrappers 24 in an overlapping manner. For example, the tobacco rod 21 may be wrapped with a first wrapper 241, and the filter rod 22 may be wrapped with wrappers 242, 243, and 244. In addition, the cigarette 2 may be entirely wrapped again with a single wrapper 245. For example, when the filter rod 22 includes a plurality of segments, the plurality of segments may be wrapped with the wrappers 242, 243, and 244, respectively.

The first wrapper 241 and the second wrapper 242 may be formed of general filter wrapping paper. For example, the first wrapper 241 and the second wrapper 242 may be porous wrapping paper or non-porous wrapping paper. In addition, the first wrapper 241 and the second wrapper 242 may be formed of oil-proof paper and/or an aluminum laminated wrapping material.

The third wrapper 243 may be formed of hard wrapping paper. For example, the basis weight of the third wrapper 243 may be in a range of about 88 g/m² to about 96 g/m², and may be desirably in a range of about 90 g/m² to about 94 g/m². In addition, the thickness of the third wrapper 243 may be in a range of about 120 μm to about 130 μm, and may be desirably about 125 μm.

The fourth wrapper 244 may be formed of oilproof hard wrapping paper. For example, the basis weight of the fourth wrapper 244 may be in a range of about 88 g/m² to about 96 g/m², and may be desirably in a range of about 90 g/m² to about 94 g/m². In addition, the thickness of the fourth wrapper 244 may be in a range of about 120 μm to about 130 μm, and may be desirably about 125 μm.

The fifth wrapper 245 may be formed of sterile paper (e.g., MFW). Here, the sterile paper (MFW) may refer to paper specially prepared such that it has enhanced tensile strength, water resistance, smoothness, or the like, compared to general paper. For example, the basis weight of the fifth wrapper 245 may be in a range of about 57 g/m² to about 63 g/m², and may be desirably about 60 g/m². In addition, the thickness of the fifth wrapper 245 may be in a range of about 64 μm to about 70 μm, and may be desirably about 67 μm.

The fifth wrapper 245 may have a predetermined material internally added thereto. The material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not be necessarily used, but any material having such properties described above may be applied to (or used to coat) the fifth wrapper 245 without limitation.

The fifth wrapper 245 may prevent the cigarette 2 from burning. In general, there is a probability that the cigarette 2 burns as the tobacco rod 21 is overheated by the heater 13. For example, when the temperature rises above an ignition point of any one of materials included in the tobacco rod 21, the cigarette 2 may burn. According to an embodiment, the cigarette 2 may be prevented from burning in this case, because the fifth wrapper 245 includes a non-combustible material.

In addition, the fifth wrapper 245 may prevent an aerosol generating device from being contaminated by substances produced in the cigarette 2. For example, liquid substances may be produced in the cigarette 2 by puffs from the user. For example, as an aerosol generated in the cigarette 2 is cooled by external air, liquid substances (e.g., water, etc.) may be produced. In this case, wrapping the cigarette 2 with the fifth wrapper 245 may prevent the liquid substances produced in the cigarette 2 from leaking out of the cigarette 2.

The tobacco rod 21 may include an aerosol generating material. The aerosol generating material may include, for example, at least one of glycerin, propylene glycol, ethylene glycol, dipropylene glycol, diethylene glycol, triethylene glycol, tetraethylene glycol, or oleyl alcohol. However, embodiments are not limited thereto. The tobacco rod 21 may also include other additives such as, for example, a flavoring agent, a wetting agent, and/or an organic acid. In addition, the tobacco rod 21 may include a flavoring liquid such as menthol or a moisturizing agent that is added as being sprayed onto the tobacco rod 21.

The tobacco rod 21 may be manufactured in various forms. For example, the tobacco rod 21 may be formed as a sheet or a strand. Alternatively, the tobacco rod 21 may be formed of tobacco leaves finely cut from a tobacco sheet. In addition, the tobacco rod 21 may be enveloped by a thermally conductive material. The thermally conductive material may be, for example, a metal foil such as aluminum foil. However, embodiments are not limited thereto. For example, the thermally conductive material enveloping the tobacco rod 21 may evenly distribute the heat transferred to the tobacco rod 21 to improve the conductivity of the heat to be applied to the tobacco rod 21, thereby improving the taste of tobacco. In addition, the thermally conductive material enveloping the tobacco rod 21 may function as a susceptor heated by an induction heater. In this case, although not shown, the tobacco rod 21 may further include an additional susceptor in addition to the thermally conductive material enveloping the outside thereof.

The filter rod 22 may be a cellulose acetate filter. However, there is no limit to the shape of the filter rod 22. For example, the filter rod 22 may be a cylindrical rod, or a tubular rod including a hollow therein. The filter rod 22 may also be a recess-type rod. For example, when the filter rod 22 includes a plurality of segments, at least one of the segments may be manufactured in a different shape.

A first segment of the filter rod 22 may be a cellulose acetate filter. For example, the first segment may be a tubular structure including a hollow therein. The first segment may prevent internal materials of the tobacco rod 21 from being pushed back when the heater 13 is inserted into the tobacco rod 21 and may cool the aerosol. A desirable diameter of the hollow included in the first segment may be adopted from a range of about 2 mm to about 4.5 mm. However, embodiments are not limited thereto.

A desirable length of the first segment may be adopted from a range of about 4 mm to about 30 mm. However, embodiments are not limited thereto. Desirably, the length of the second segment may be 10 mm. However, embodiments are not limited thereto.

The first segment may have a hardness that is adjustable through an adjustment of the content of a plasticizer in the process of manufacturing the first segment. In addition, the first segment may be manufactured by inserting a structure such as a film or a tube of the same or different materials therein (e.g., in the hollow).

A second segment of the filter rod 22 may cool an aerosol that is generated as the heater 13 heats the tobacco rod 21. The user may thus inhale the aerosol cooled down to a suitable temperature.

The length or diameter of the second segment may be determined in various ways according to the shape of the cigarette 2. For example, a desirable length of the second segment may be adopted from a range of about 7 mm to about 20 mm. Desirably, the length of the second segment may be about 14 mm. However, embodiments are not limited thereto.

The second segment may be manufactured by weaving a polymer fiber. In this case, a flavoring liquid may be applied to a fiber formed of a polymer. As another example, the second segment may be manufactured by weaving a separate fiber to which a flavoring liquid is applied and the fiber formed of the polymer together. As still another example, the second segment may be formed with a crimped polymer sheet.

For example, the polymer may be prepared with a material selected from the group consisting of polyethylene (PE), polypropylene (PP), polyvinyl chloride (PVC), polyethylene terephthalate (PET), polylactic acid (PLA), cellulose acetate (CA,) and aluminum foil.

As the second segment is formed with the woven polymer fiber or the crimped polymer sheet, the second segment may include a single channel or a plurality of channels extending in a longitudinal direction. A channel used herein may refer to a path through which a gas (e.g., air or aerosol) passes.

For example, the second segment formed with the crimped polymer sheet may be formed of a material having a thickness between about 5 μm and about 300 μm, for example, between about 10 μm and about 250 μm. In addition, the total surface area of the second segment may be between about 300 mm² and about 1000 mm². Further, an aerosol cooling element may be formed from a material having a specific surface area between about 10 mm²/mg and about 100 mm²/mg.

Meanwhile, the second segment may include a thread containing a volatile flavor ingredient. The volatile flavor ingredient may be menthol. However, embodiments are not limited thereto. For example, the thread may be filled with a sufficient amount of menthol to provide at least 1.5 mg of menthol to the second segment.

A third segment of the filter rod 22 may be a cellulose acetate filter. A desirable length of the third segment may be adopted from a range of about 4 mm to about 20 mm. For example, the length of the third segment may be about 12 mm. However, embodiments are not limited thereto.

The third segment may be manufactured such that a flavor is generated by spraying a flavoring liquid onto the third segment in the process of manufacturing the third segment. Alternatively, a separate fiber to which the flavoring liquid is applied may be inserted into the third segment. An aerosol generated in the tobacco rod 21 may be cooled as it passes through the second segment of the filter rod 22, and the cooled aerosol may pass through the third segment into the user. Accordingly, when a flavoring element is added to the third segment, the flavor carried to the user may last much longer.

In addition, the filter rod 22 may include at least one capsule 23. Here, the capsule 23 may perform a function of generating a flavor or a function of generating an aerosol. For example, the capsule 23 may have a structure in which a liquid containing a fragrance is wrapped with a film. The capsule 23 may have a spherical or cylindrical shape. However, embodiments are not limited thereto.

Referring to FIG. 5, a cigarette 3 may further include a front end plug 33. The front end plug 33 may be disposed on one side of a tobacco rod 31 opposite to a filter rod 32. The front end plug 33 may prevent the tobacco rod 31 from escaping to the outside, and may also prevent an aerosol liquefied in the tobacco rod 31 during smoking from flowing into an aerosol generating device (e.g., the aerosol generating device 1 of FIGS. 1 to 3).

The filter rod 32 may include a first segment 321 and a second segment 322. Here, the first segment 321 may correspond to the first segment of the filter rod 22 of FIG. 4, and the second segment 322 may correspond to the third segment of the filter rod 22 of FIG. 4.

A diameter and a total length of the cigarette 3 may correspond to the diameter and the total length of the cigarette 2 of FIG. 4. For example, the length of the front end plug 33 may be about 7 mm, the length of the tobacco rod 31 may be about 15 mm, the length of the first segment 321 may be about 12 mm, and the length of the second segment 322 may be about 14 mm. However, embodiments are not limited thereto.

The cigarette 3 may be wrapped with at least one wrapper 35. The wrapper 35 may have at least one hole through which external air is introduced or internal gas flows out. For example, the front end plug 33 may be wrapped with a first wrapper 351, the tobacco rod 31 may be wrapped with a second wrapper 352, the first segment 321 may be wrapped with a third wrapper 353, and the second segment 322 may be wrapped with a fourth wrapper 354. In addition, the cigarette 3 may be entirely wrapped again with a fifth wrapper 355.

In addition, at least one perforation 36 may be formed in the fifth wrapper 355. For example, the perforation 36 may be formed in an area surrounding the tobacco rod 31. However, embodiments are not limited thereto. The perforation 36 may perform a function of transferring heat generated by the heater 13 shown in FIGS. 2 and 3 to the inside of the tobacco rod 31.

In addition, the second segment 322 may include at least one capsule 34. Here, the capsule 34 may perform a function of generating a flavor or a function of generating an aerosol. For example, the capsule 34 may have a structure in which a liquid containing a fragrance is wrapped with a film. The capsule 34 may have a spherical or cylindrical shape. However, embodiments are not limited thereto.

The first wrapper 351 may be a combination of general filter wrapping paper and a metal foil such as aluminum foil. For example, the total thickness of the first wrapper 351 may be in a range of about 45 μm to about 55 μm, and may be desirably about 50.3 μm. Further, the thickness of the metal foil of the first wrapper 351 may be in a range of about 6 μm to about 7 μm, and may be desirably about 6.3 μm. In addition, the basis weight of the first wrapper 351 may be in a range of about 50 g/m² to about 55 g/m², and may be desirably about 53 g/m².

The second wrapper 352 and the third wrapper 353 may be formed with general filter wrapping paper. For example, the second wrapper 352 and the third wrapper 353 may be porous wrapping paper or non-porous wrapping paper.

For example, the porosity of the second wrapper 352 may be 35000 CU. However, embodiments are not limited thereto. Further, the thickness of the second wrapper 352 may be in a range of about 70 μm to about 80 μm, and may be desirably about 78 μm. In addition, the basis weight of the second wrapper 352 may be in a range of about 20 g/m² to about 25 g/m², and may be desirably about 23.5 g/m².

For example, the porosity of the third wrapper 353 may be 24000 CU. However, embodiments are not limited thereto. Further, the thickness of the third wrapper 353 may be in a range of about 60 μm to about 70 μm, and may be desirably about 68 μm. In addition, the basis weight of the third wrapper 353 may be in a range of about 20 g/m² to about 25 g/m², and may be desirably about 21 g/m².

The fourth wrapper 354 may be formed with polylactic acid (PLA) laminated paper. Here, the PLA laminated paper may refer to three-ply paper including a paper layer, a PLA layer, and a paper layer. For example, the thickness of the fourth wrapper 354 may be in a range of about 100 μm to about 120 μm, and may be desirably about 110 μm. In addition, the basis weight of the fourth wrapper 354 may be in a range of about 80 g/m² to about 100 g/m², and may be desirably about 88 g/m².

The fifth wrapper 355 may be formed of sterile paper (e.g., MFW). Here, the sterile paper (MFW) may refer to paper specially prepared such that it has enhanced tensile strength, water resistance, smoothness, or the like, compared to general paper. For example, the basis weight of the fifth wrapper 355 may be in a range of about 57 g/m² to about 63 g/m², and may be desirably about 60 g/m². Further, the thickness of the fifth wrapper 355 may be in a range of about 64 μm to about 70 μm, and may be desirably about 67 μm.

The fifth wrapper 355 may have a predetermined material internally added thereto. The material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not be necessarily used, but any material having such properties described above may be applied to (or used to coat) the fifth wrapper 355 without limitation.

The front end plug 33 may be formed of cellulose acetate. For example, the front end plug 33 may be manufactured by adding a plasticizer (e.g., triacetin) to cellulose acetate tow. The mono denier of a filament of the cellulose acetate tow may be in a range of about 1.0 to about 10.0, and may be desirably in a range of about 4.0 to about 6.0. The mono denier of the filament of the front end plug 33 may be more desirably about 5.0. In addition, a cross section of the filament of the front end plug 33 may be Y-shaped. The total denier of the front end plug 33 may be in a range of about 20000 to about 30000, and may be desirably in a range of about 25000 to about 30000. The total denier of the front end plug 33 may be more desirably 28000.

In addition, as needed, the front end plug 33 may include at least one channel, and a cross-sectional shape of the channel may be provided in various ways.

The tobacco rod 31 may correspond to the tobacco rod 21 described above with reference to FIG. 4. Thus, a detailed description of the tobacco rod 31 will be omitted here.

The first segment 321 may be formed of cellulose acetate. For example, the first segment may be a tubular structure including a hollow therein. The first segment 321 may be manufactured by adding a plasticizer (e.g., triacetin) to cellulose acetate tow. For example, the mono denier and the total denier of the first segment 321 may be the same as the mono denier and the total denier of the front end plug 33.

The second segment 322 may be formed of cellulose acetate. The mono denier of a filament of the second segment 322 may be in a range of about 1.0 to about 10.0, and may be desirably in a range of about 8.0 to about 10.0. The mono denier of the filament of the second segment 322 may be more desirably 9.0. In addition, a cross section of the filament of the second segment 322 may be Y-shaped. The total denier of the second segment 322 may be in a range of about 20000 to about 30000, and may be desirably 25000.

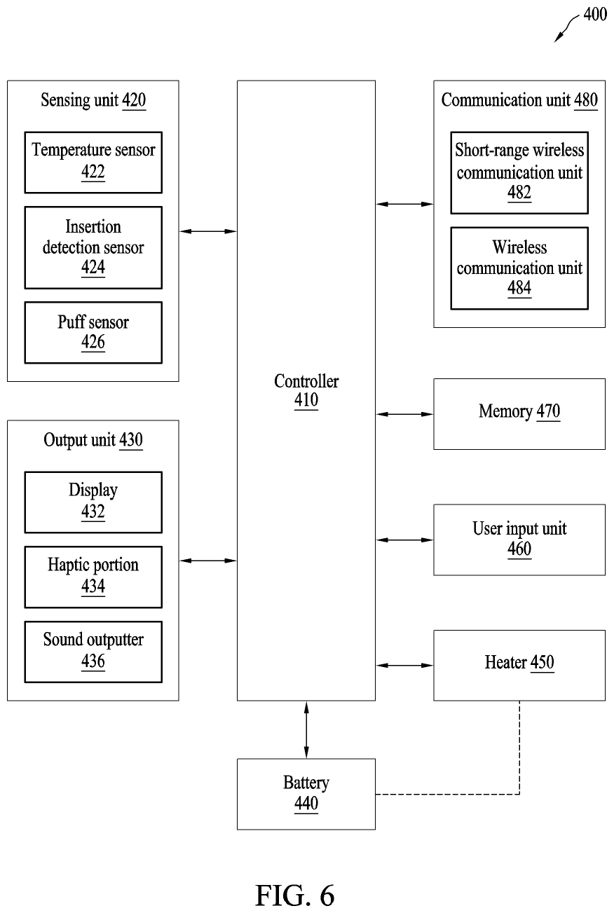

FIG. 6 is a block diagram of an aerosol generating device 400 according to an embodiment.

The aerosol generating device 400 may include a controller 410, a sensing unit 420, an output unit 430, a battery 440, a heater 450, a user input unit 460, a memory 470, and a communication unit 480. However, the internal structure of the aerosol generating device 400 is not limited to what is shown in FIG. 6. It is to be understood by one of ordinary skill in the art to which the disclosure pertains that some of the components shown in FIG. 6 may be omitted or new components may be added according to the design of the aerosol generating device 400.

The sensing unit 420 may sense a state of the aerosol generating device 400 or a state of an environment around the aerosol generating device 400, and transmit sensing information obtained through the sensing to the controller 410. Based on the sensing information, the controller 410 may control the aerosol generating device 400 to control operations of the heater 450, restrict smoking, determine whether an aerosol generating article (e.g., a cigarette, a cartridge, etc.) is inserted, display a notification, and perform other functions.

The sensing unit 420 may include at least one of a temperature sensor 422, an insertion detection sensor 424, or a puff sensor 426. However, embodiments are not limited thereto.

The temperature sensor 422 may sense a temperature at which the heater 450 (or an aerosol generating material) is heated. The aerosol generating device 400 may include a separate temperature sensor for sensing the temperature of the heater 450, or the heater 450 itself may perform a function as a temperature sensor. Alternatively, the temperature sensor 422 may be arranged around the battery 440 to monitor the temperature of the battery 440.

The insertion detection sensor 424 may sense whether the aerosol generating article is inserted or removed. The insertion detection sensor 424 may include, for example, at least one of a film sensor, a pressure sensor, a light sensor, a resistive sensor, a capacitive sensor, an inductive sensor, or an infrared sensor, which may sense a signal change by the insertion or removal of the aerosol generating article.

The puff sensor 426 may sense a puff from a user based on various physical changes in an airflow path or airflow channel. For example, the puff sensor 426 may sense the puff of the user based on any one of a temperature change, a flow change, a voltage change, and a pressure change.

The sensing unit 420 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 422 through 426 described above. A function of each sensor may be intuitively inferable from its name by one of ordinary skill in the art, and thus, a more detailed description thereof will be omitted here.

The output unit 430 may output information about the state of the aerosol generating device 400 and provide the information to the user. The output unit 430 may include at least one of a display 432, a haptic portion 434, or a sound outputter 436. However, embodiments are not limited thereto. When the display 432 and a touchpad are provided in a layered structure to form a touchscreen, the display 432 may be used as an input device in addition to an output device.

The display 432 may visually provide information about the aerosol generating device 400 to the user. The information about the aerosol generating device 400 may include, for example, a charging/discharging state of the battery 440 of the aerosol generating device 400, a preheating state of the heater 450, an insertion/removal state of the aerosol generating article, a limited usage state (e.g., an abnormal article detected) of the aerosol generating device 400, or the like, and the display 432 may externally output the information. The display 432 may be, for example, a liquid-crystal display panel (LCD), an organic light-emitting display panel (OLED), or the like. The display 432 may also be in the form of a light-emitting diode (LED) device.

The haptic portion 434 may provide information about the aerosol generating device 400 to the user in a haptic way by converting an electrical signal into a mechanical stimulus or an electrical stimulus. The haptic portion 434 may include, for example, a motor, a piezoelectric element, or an electrical stimulation device.

The sound outputter 436 may provide information about the aerosol generating device 400 to the user in an auditory way. For example, the sound outputter 436 may convert an electrical signal into a sound signal and externally output the sound signal.

The battery 440 may supply power to be used to operate the aerosol generating device 400. The battery 440 may supply power to heat the heater 450. In addition, the battery 440 may supply power required for operations of the other components (e.g., the sensing unit 420, the output unit 430, the user input unit 460, the memory 470, and the communication unit 480) included in the aerosol generating device 400. The battery 440 may be a rechargeable battery or a disposable battery. The battery 440 may be, for example, a lithium polymer (LiPoly) battery. However, embodiments are not limited thereto.

The heater 450 may receive power from the battery 440 to heat the aerosol generating material. Although not shown in FIG. 6, the aerosol generating device 400 may further include a power conversion circuit (e.g., a direct current (DC)-to-DC (DC/DC) converter) that converts power of the battery 440 and supplies the power to the heater 450. In addition, when the aerosol generating device 400 generates an aerosol in an induction heating manner, the aerosol generating device 400 may further include a DC-to-alternating current (AC) (DC/AC) converter that converts DC power of the battery 440 into AC power.

The controller 410, the sensing unit 420, the output unit 430, the user input unit 460, the memory 470, and the communication unit 480 may receive power from the battery 440 to perform functions. Although not shown in FIG. 6, the aerosol generating device 400 may further include a power conversion circuit, for example, a low dropout (LDO) circuit or a voltage regulator circuit, which converts power of the battery 440 and supplies the power to respective components.

In an embodiment, the heater 450 may be formed of a predetermined electrically resistive material that is suitable for heating. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 450 may be implemented as a metal heating wire, a metal heating plate on which an electrically conductive track is arranged, a ceramic heating element, or the like, but is not limited thereto.

In an embodiment, the heater 450 may be an induction heater. For example, the heater 450 may include a susceptor that heats the aerosol generating material by generating heat through a magnetic field applied by a coil.

In an embodiment, the heater 450 may include a plurality of heaters. For example, the heater 450 may include a first heater for heating a cigarette and a second heater for heating a liquid.

The user input unit 460 may receive information input from the user or may output information to the user. For example, the user input unit 460 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 6, the aerosol generating device 400 may further include a connection interface such as a universal serial bus (USB) interface, and may be connected to another external device through the connection interface such as a USB interface to transmit and receive information or to charge the battery 440.

The memory 470, which is hardware for storing various pieces of data processed in the aerosol generating device 400, may store data processed by the controller 410 and data to be processed thereby. The memory 470 may include at least one type of storage medium of a flash memory type memory, a hard disk type memory, a multimedia card micro type memory, a card type memory (e.g., an SD or XE memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 470 may store an operating time of the aerosol generating device 400, a maximum number of puffs, a current number of puffs, at least one temperature profile, data associated with a smoking pattern of the user, or the like.

The communication unit 480 may include at least one component for communicating with another electronic device. For example, the communication unit 480 may include a short-range wireless communication unit 482 and a wireless communication unit 484.

The short-range wireless communication unit 482 may include a Bluetooth communication unit, a BLE communication unit, a near field communication unit, a WLAN (Wi-Fi) communication unit, a ZigBee communication unit, an infrared data association (IrDA) communication unit, a Wi-Fi direct (WFD) communication unit, an ultra-wideband (UWB) communication unit, and an Ant+communication unit. However, embodiments are not limited thereto.

The wireless communication unit 484 may include, for example, a cellular network communicator, an Internet communicator, a computer network (e.g., a local area network (LAN) or a wide-area network (WAN)) communicator, or the like. However, embodiments are not limited thereto. The wireless communication unit 484 may use subscriber information (e.g., international mobile subscriber identity (IMSI)) to identify and authenticate the aerosol generating device 400 in a communication network.

The controller 410 may control the overall operation of the aerosol generating device 400. In an embodiment, the controller 410 may include at least one processor. The at least one processor may be implemented as an array of a plurality of logic gates, or may be implemented as a combination of a general-purpose microprocessor and a memory in which a program executable by the microprocessor is stored. In addition, it is to be understood by one of ordinary skill in the art to which the disclosure pertains that it may be implemented in other types of hardware.

The controller 410 may control the temperature of the heater 450 by controlling the supply of power from the battery 440 to the heater 450. For example, the controller 410 may control the supply of power by controlling the switching of a switching element between the battery 440 and the heater 450. In another example, a direct heating circuit may control the supply of power to the heater 450 according to a control command from the controller 410.

The controller 410 may analyze a sensing result obtained by the sensing of the sensing unit 420 and control processes to be performed thereafter. For example, the controller 410 may control power to be supplied to the heater 450 to start or end an operation of the heater 450 based on the sensing result obtained by the sensing unit 420. As another example, the controller 410 may control an amount of power to be supplied to the heater 450 and a time for which the power is to be supplied, such that the heater 450 may be heated up to a predetermined temperature or maintained at a desired temperature, based on the sensing result obtained by the sensing unit 420.

The controller 410 may control the output unit 430 based on the sensing result obtained by the sensing unit 420. For example, when the number of puffs counted through the puff sensor 426 reaches a preset number, the controller 410 may inform the user that the aerosol generating device 400 is to be ended soon, through at least one of the display 432, the haptic portion 434, or the sound outputter 436.

In an embodiment, the controller 410 may control a power supply time and/or a power supply amount for the heater 450 according to a state of the aerosol generating article sensed by the sensing unit 420. For example, when the aerosol generating article is in an over-humidified state, the controller 410 may control the power supply time for an inductive coil to increase a preheating time, compared to a case where the aerosol generating article is in a general state.

One embodiment may also be implemented in the form of a recording medium including instructions executable by a computer, such as a program module executable by the computer. A computer-readable medium may be any available medium that can be accessed by a computer and includes a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

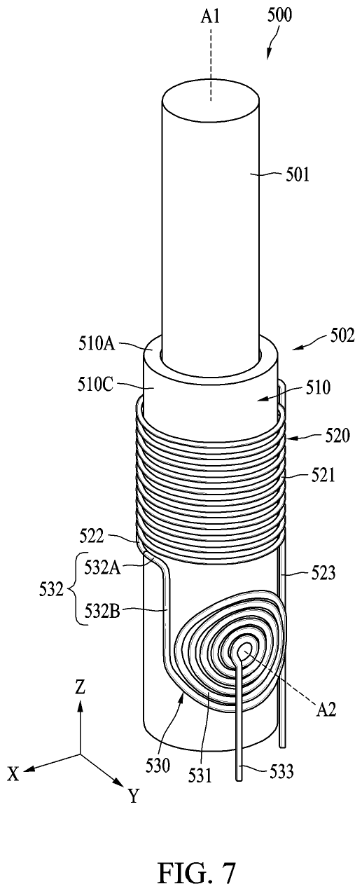

FIGS. 7 to 9 are views illustrating a portion of an aerosol generating device according to an embodiment.

Referring to FIGS. 7 to 9, an aerosol generating system 500 may include an aerosol generating article 501 (e.g., the cigarette 2) and a heating body 502 (e.g., the heater 13 or 450) configured to heat the aerosol generating article 501.

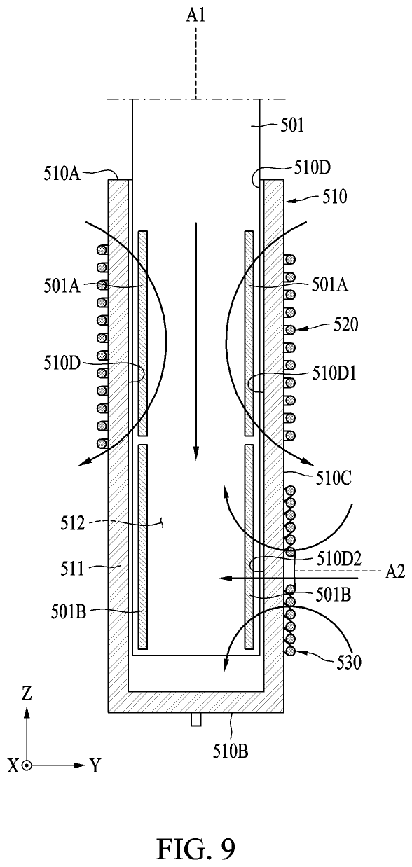

The aerosol generating article 501 may include a plurality of susceptors 501A and 501B (see FIG. 9). For example, the aerosol generating article 501 may include at least one first susceptor 501A positioned relatively downstream, and at least one second susceptor 501B positioned relatively upstream. The term “downstream” refers to a general direction in which the aerosol moves from where it is generated toward the mouth of a user in the aerosol generating article 501 (e.g., cigarette) during smoking, and the term “upstream” refers to its opposite direction.

The heating body 502 may include a heating housing 510 configured to heat the aerosol generating article 501.

The heating housing 510 may include a body portion 511 having a first surface 510A (e.g., a first end surface or an upper end surface), a second surface 510B (e.g., a second end surface or a lower end surface) opposite to the first surface 510A, an outer side surface 510C between the first surface 510A and the second surface 510B, and an inner side surface 510D between the first surface 510A and the second surface 510B. The first surface 510A may form an open surface, while the second surface 510B may form a closed surface. The outer side surface 510C may include a first outer region 510C1 (e.g., an upper outer region) connected to the first surface 510A, and a second outer region 510C2 (e.g., a lower outer region) connected to the second surface 510B. The inner side surface 510D may include a first inner region 510D1 (e.g., an upper inner region) connected to the first surface 510A, and a second inner region 510D2 (e.g., a lower inner region) connected to the second surface 510B.

The heating housing 510 may include a hollow portion 512 defined by the inner side surface 510D. The hollow portion 512 may be configured to at least partially receive the aerosol generating article 501.

The heating body 502 may include a plurality of coils 520 and 530 configured to generate magnetic fields in different directions, respectively. In an embodiment, the heating body 502 may include a first coil 520 configured to generate a magnetic field substantially in a first direction (e.g., −Z direction), and a second coil 530 configured to generate a magnetic field substantially in a second direction (e.g., −Y direction) intersecting with (e.g., orthogonal to) the first direction.

The first coil 520 may be configured to be magnetically coupled to the first susceptor 501A. The first coil 520 may include a first winding portion 521 that has a first axis A1 (e.g., +Z axis), at least partially surrounds the outer side surface 510C, and winds in a first helical direction (e.g., a clockwise direction) with respect to the first axis A1. Here, the first axis A1 may also be defined as an axis in a longitudinal direction of the body portion 511. In an embodiment, the first winding portion 521 may be positioned in the first outer region 510C1.

In an embodiment, the first coil 520 may include a first connecting portion 522 forming a first end portion (e.g., a lower end portion) of the first winding portion 521. The first connecting portion 522 may be electrically connected to the second coil 530. In an embodiment, the first connecting portion 522 may be positioned in the first outer region 510C1. In some embodiments, the first connecting portion 522 may at least partially surround the first outer region 510C1 with respect to the first axis A1.

In an embodiment, the first coil 520 may include a second connecting portion 523 forming a second end portion (e.g., an upper end portion) of the first winding portion 521. The second connecting portion 523 may be electrically connected to a controller (e.g., the controller 12 or 410) of an aerosol generating device (e.g., the aerosol generating device 1 or 400). In an embodiment, the second connecting portion 523 may traverse the first winding portion 521 and extend in a direction opposite to an axial direction (e.g., a +Z direction) of the first axis A1 while being spaced apart from the outer side surface 510C.

The second coil 530 may be configured to be magnetically coupled to the second susceptor 501B. The second coil 530 may include a second winding portion 531 that has a second axis A2 (e.g., a +Y axis) intersecting with (e.g., orthogonal to) the first axis A1, is positioned on the outer side surface 510C, and winds in a second helical direction (e.g., a clockwise direction) with respect to the second axis A2. Here, the second axis A2 may be defined as a normal direction of the outer side surface 510C or a radial direction of the body portion 511. In an embodiment, the second winding portion 531 may be positioned in the second outer region 510C2.

In an embodiment, the second coil 530 may include a third connecting portion 532 forming a first end portion (e.g., a left end portion) of the second winding portion 531. The third connecting portion 532 may be electrically connected to the first coil 520. In an embodiment, the third connecting portion 532 may include a first portion 532A physically and electrically connected to the first connecting portion 522, and a second portion 532B physically and electrically connected to the first portion 532A and the second winding portion 531. In some embodiments, the first portion 532A may be positioned in the first outer region 510C1 while at least partially surrounding the first outer region 510C1 with respect to the first axis A1, and the second portion 532B may extend on the second outer region 510C2 in the axial direction of the first axis A1 and extend on the first outer region 510C1 while at least partially bending.

In an embodiment, the second coil 530 may include a fourth connecting portion 533 forming a second end portion (e.g., a central end portion) of the second winding portion 531. The fourth connecting portion 533 may be electrically connected to the controller (e.g., the controller 12 or 410) of the aerosol generating device (e.g., the aerosol generating device 1 or 400). In an embodiment, the fourth connecting portion 533 may at least partially traverse the second winding portion 531 and extend in the direction opposite to the axial direction (e.g., the +Z direction) of the first axis A1 while being spaced apart from the outer side surface 510C. In some embodiments, the fourth connecting portion 533 may run substantially parallel to the second connecting portion 523.

In an embodiment, the first coil 520 and the second coil 530 may not be directly connected on the outer side surface 510C. For example, the first coil 520 may not include the first connecting portion 522, and the second coil 530 may not include the third connecting portion 532.

In some embodiments, the heating body 502 may include a third coil (not shown) configured to generate a magnetic field having a direction (e.g., a −X direction) intersecting with (e.g., orthogonal to) the direction of the magnetic field generated by the first coil 520 and the direction of the magnetic field generated by the second coil 530. The third coil may be configured to be magnetically coupled to the second susceptor 501B. The third coil may include a third winding portion that winds in a third helical direction (e.g., a clockwise direction) with respect to a third axis intersecting with (e.g., orthogonal to) the first axis and the second axis.

In an embodiment, the third coil may include a fifth connecting portion physically and electrically connected to the first winding portion 521 and/or the second winding portion 531. In an embodiment, the third coil may not include the fifth connecting portion.

In an embodiment, the third coil may include a sixth connecting portion electrically connected to the controller (e.g., the controller 12 or 410) of the aerosol generating device (e.g., the aerosol generating device 1 or 400).

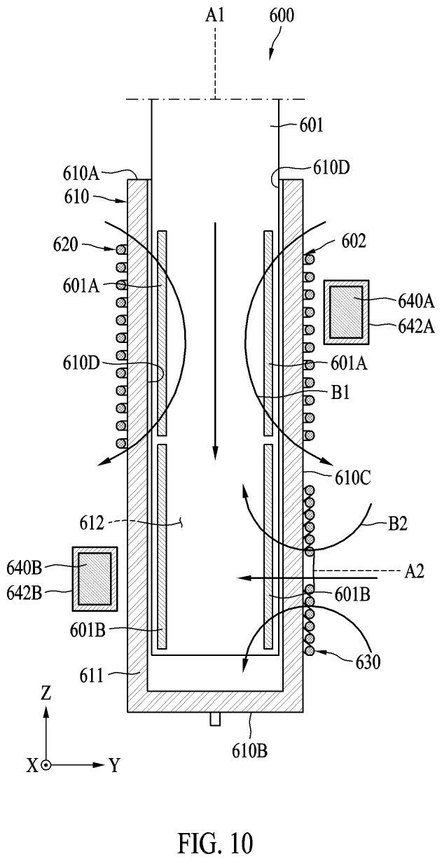

FIG. 10 is a cross-sectional view of a portion of an aerosol generating system according to an embodiment.

Referring to FIG. 10, an aerosol generating system 600 may include an aerosol generating article 601 and an aerosol generating device 602.

As shown in FIG. 10, the aerosol generating article 601 may include one or more susceptors 601A and 601B. For example, the aerosol generating article 601 may include at least one first susceptor 601A positioned relatively downstream and/or at least one second susceptor 601B positioned relatively upstream. In another embodiment, the one or more susceptors 601A and 601B may not be included in the aerosol generating article 601 and may be included in the aerosol generating device 602.

In an embodiment, the one or more susceptors 601A and 601B may have various thicknesses (e.g., a dimension in +/−X direction and/or +/−Y direction), various lengths (e.g., a dimension in +/−Z direction), various materials, and/or various parameters. The various parameters may determine the types of the susceptors 601A and 601B, and may further determine the types of various aerosol generating articles 601.

The aerosol generating device 602 may include a heating housing 610. The heating housing 610 may include a body portion 611 and a hollow portion 612. The body portion 611 may include, for example, a first surface 610A, a second surface 610B opposite to the first surface 610A, an outer side surface 610C extending between the first surface 610A and the second surface 610B, and an inner side surface 610D that is opposite to the outer side surface 610C and extends between the first surface 610A and the second surface 610B.

The aerosol generating device 602 may include one or more coils 620 and 630. In an embodiment, the aerosol generating device 602 may include a first coil 620 and a second coil 630. In an embodiment, the aerosol generating device 602 may include one of the first coil 620 and the second coil 630. In an embodiment, the aerosol generating device 602 may include a third coil (not shown) configured to generate a magnetic field in a direction (e.g., a −X direction) intersecting with (e.g., orthogonal to) a direction of a magnetic field generated by the first coil 620 and a direction of a magnetic field generated by the second coil 630.

In an embodiment, applying a current and/or a voltage to the first coil 620 may be independent of applying a current and/or a voltage to the second coil 630. In an embodiment, applying a current and/or a voltage to the first coil 620 may be in link with applying a current and/or a voltage to the second coil 630.

In an embodiment, the aerosol generating device 602 may include a first magnetic sensor 640A configured to detect a change in a first magnetic field B1 of the first coil 620. When a current and/or a voltage is applied to the first coil 620, the first magnetic sensor 640A may detect a change in the magnitude and/or strength of the first magnetic field B1 generated by the first coil 620. In an embodiment, the first magnetic sensor 640A may include a Hall sensor.

In an embodiment, the aerosol generating device 602 (e.g., the controller 410) may determine a profile for changing the current and/or the voltage applied to the first coil 620 based on the change in the first magnetic field B1 detected by the first magnetic sensor 640A. As a result, the current and/or the voltage applied to the first coil 620 may vary depending on the type of the aerosol generating article 601, such that the first magnetic field B1 generated by the first coil 620 may change according to the profile. To this end, information on the change in the first magnetic field B1 detected by the first magnetic sensor 640A may be used to recognize at least one characteristic of the aerosol generating article 601. Thus, the aerosol generating device 602 may be configured to fit various types of aerosol generating articles 601.

In an embodiment, the aerosol generating device 602 (e.g., the controller 410) may perform puff detection or puff counting (i.e., detect or count user's inhalation on the aerosol generating article 601) based on the change in the first magnetic field B1 detected by the first magnetic sensor 640A.

In an embodiment, the first magnetic sensor 640A may be disposed adjacent to the first coil 620. For example, the first magnetic sensor 640A may be spaced apart by a small distance from the first coil 620.

In an embodiment, the first coil 620 and the first magnetic sensor 640A may be arranged in one axis direction (e.g., +/−Y direction) of the heating housing 620. Axis direction may refer to a direction in which a certain dimension such as a length, width, depth, or diameter is measured. The first magnetic sensor 640A may at least partially overlap the first coil 620 in a normal direction (e.g., +/−Y direction) of the outer side surface 610C of the body portion 611.

In an embodiment, the first magnetic sensor 640A may be disposed on a central portion of the first coil 620 along the first axis A1 of the first coil 620.

In an embodiment, the aerosol generating device 602 may include a second magnetic sensor 640B configured to detect a change in a second magnetic field B2 of the second coil 630. When a current and/or a voltage is applied to the second coil 630, the second magnetic sensor 640B may detect a change in the magnitude and/or strength of the second magnetic field B2 generated by the second coil 630. In an embodiment, the second magnetic sensor 640B may include a Hall sensor.

In an embodiment, the aerosol generating device 602 (e.g., the controller 410) may determine a profile for changing the current and/or the voltage applied to the second coil 630 based on the change in the second magnetic field B2 detected by the second magnetic sensor 640B. As a result, the current and/or the voltage applied to the second coil 630 may vary depending on the type of the aerosol generating article 601, such that the second magnetic field B2 generated by the second coil 630 may change according to the profile. To this end, information on the change in the second magnetic field B2 detected by the second magnetic sensor 640B may be used to recognize at least one characteristic of the aerosol generating article 601.

In an embodiment, the aerosol generating device 602 (e.g., the controller 410) may perform puff detection or puff counting (i.e., detect or count user's inhalation on the aerosol generating article 601) based on the change in the second magnetic field B2 detected by the second magnetic sensor 640B.

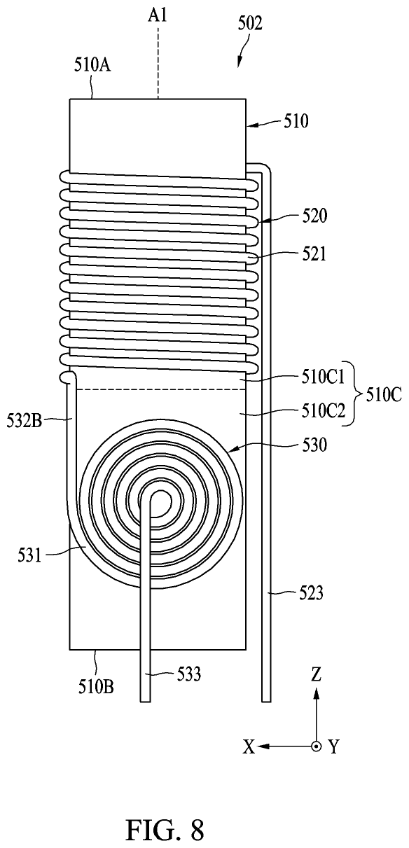

In an embodiment, the second magnetic sensor 640B may be disposed in a region of the body portion 611, other than a region in which the second coil 630 is disposed (e.g., a region of the second outer region 510C2 of FIG. 8 which has a normal direction of the +/−Y direction). In an embodiment, the second magnetic sensor 640B may be disposed opposite to the second coil 630 on the body portion 611.

In an embodiment, the second coil 630 and the second magnetic sensor 640B may be arranged in one axis direction (e.g., +/−Y direction) of the heating housing 620. The second magnetic sensor 640B may at least partially overlap the second coil 630 in a normal direction (e.g., +/−Y direction) of the outer side surface 610C of the body portion 611.

In an embodiment, the second magnetic sensor 640B may be disposed on an extension line of the second axis A2 of the second coil 630.

The aerosol generating device 602 may include as many magnetic sensors as coils. For example, the aerosol generating device 602 may include a first magnetic sensor 640A, a second magnetic sensor 640B, and a third magnetic sensor (not shown) configured to detect changes in magnetic fields of a first coil, a second coil, and a third coil (not shown), respectively.

In an embodiment, the aerosol generating device 602 may include one or more shielding portions 642A and 642B configured to shield the one or more magnetic sensors 640A and 640B from the outside. For example, the shielding portions 642A and 642B may shield the magnetic sensors 640A and 640B from external magnetic or electromagnetic noise to improve the sensitivity of the magnetic sensors 640A and 640B.

In an embodiment, the aerosol generating device 602 may include a first shielding portion 642A configured to shield the first magnetic sensor 640A and a second shielding portion 642B configured to shield the second magnetic sensor 640B. In an embodiment, the first shielding portion 642A may substantially shield a front surface of the first magnetic sensor 640A. In an embodiment, the first shielding portion 642A may substantially shield the remaining surfaces excluding a surface (e.g., a surface in the −Y direction) facing the first coil 620 among the surfaces of the first magnetic sensor 640A. In an embodiment, the second shielding portion 642B may substantially shield a front surface of the second magnetic sensor 640B. In an embodiment, the second shielding portion 642B may substantially shield the remaining surfaces excluding a surface (e.g., a surface in the +Y direction) facing the second coil 630 among the surfaces of the second magnetic sensor 640B.

In an embodiment, the aerosol generating device 602 may include at least one of the first shielding portion 642A and the second shielding portion 642B. In an embodiment, the aerosol generating device 602 may include an additional shielding portion configured to shield an additional magnetic sensor (e.g., the third magnetic sensor).

The features and aspects of any embodiment(s) described above may be combined with features and aspects of any other embodiment(s) without resulting in apparent technical conflicts.

1. An aerosol generating device, comprising:
a heating housing configured to receive an aerosol generating article;
a first coil disposed on the heating housing and configured to generate a magnetic field; and
a first magnetic sensor configured to detect a change in the magnetic field generated by the first coil.

2. The aerosol generating device of claim 1, wherein
the first magnetic sensor is disposed adjacent to the first coil.

3. The aerosol generating device of claim 1, wherein
the first coil and the first magnetic sensor are arranged to at least partially overlap in one radial direction of the heating housing.

4. The aerosol generating device of claim 1, wherein
the first coil has an axis in a longitudinal direction of the heating housing.

5. The aerosol generating device of claim 1, further comprising:
a shielding portion configured to block electromagnetic waves and arranged to at least partially surround the first magnetic sensor.

6. The aerosol generating device of claim 1, further comprising:
a second coil disposed in a region of the heating housing which is different from a region in which the first coil is disposed, and configured to generate a magnetic field; and
a second magnetic sensor configured to detect a change in the magnetic field generated by the second coil.

7. The aerosol generating device of claim 6, wherein
the second magnetic sensor is disposed opposite to the second coil on the heating housing.

8. The aerosol generating device of claim 6, wherein
the second coil and the second magnetic sensor are arranged to at least partially overlap in one axis direction of the heating housing.

9. The aerosol generating device of claim 6, wherein
the second coil has an axis in a normal direction of a side surface of the heating housing.

10. The aerosol generating device of claim 6, further comprising:
a shielding portion configured to block electromagnetic waves and arranged to at least partially surround the second magnetic sensor.

11. An aerosol generating system, comprising:
an aerosol generating article comprising a susceptor; and
an aerosol generating device comprising:
a heating housing configured to receive the aerosol generating article;
a first coil disposed on the heating housing, positioned to be electromagnetically coupled to the susceptor when the aerosol generating article is loaded in the aerosol generating device, and configured to generate a magnetic field; and
a first magnetic sensor configured to detect a change in the magnetic field generated by the first coil.

12. The aerosol generating system of claim 11, wherein
the first magnetic sensor is disposed adjacent to the first coil.

13. The aerosol generating system of claim 11, wherein
the aerosol generating device further comprises:
a second coil disposed in a region of the heating housing which is different from a region in which the first coil is disposed, positioned to be electromagnetically coupled to the susceptor when the aerosol generating article is loaded in the aerosol generating device, and configured to generate a magnetic field; and
a second magnetic sensor configured to detect a change in the magnetic field generated by the second coil.

14. The aerosol generating device of claim 13, wherein
the second magnetic sensor is disposed opposite to the second coil on the heating housing.

15. The aerosol generating system of claim 11, wherein
the first coil and the first magnetic sensor are arranged to at least partially overlap in one radial direction of the heating housing, and the second coil and the second magnetic sensor are arranged to at least partially overlap in the axis direction of the heating housing.
